(19) United States
(12) Patent Application Publication
(10) Pub. No.: US 2012/0271741 A1
(43) Pub. Date: Oct. 25, 2012

(54) INVENTORY PRICE OPTIMIZATION WITH KEY PRICE LIST

(76) Inventor: David H. Leonard, Seal Beach, CA (US)

(21) Appl. No.: 13/540,360

(22) Filed: Jul. 2, 2012

Related U.S. Application Data
(63) Continuation-in-part of application No. 13/043,285, filed on Mar. 8, 2011.

(51) Int. Cl. G06Q 10/08

(52) U.S. Cl. 705/28

(57) ABSTRACT

Generating one or more secondary price lists from a key price list is disclosed. A first selection of the key price list is received via a user interface. The key price list is stored on a catalog database and includes a plurality of initial key prices associated with corresponding inventory stock keeping units (SKUs). A second selection of a first one of the secondary price lists is received via the user interface, followed by a first price adjustment rate for the first one of the secondary price lists. The first price adjustment rate is applied to each of the initial key prices in the key price list, and a first set of secondary prices is derived thereby. The first set of secondary prices are stored together in association with the corresponding inventory SKUs in the first one of the secondary price lists.

### CROSS-REFERENCE TO RELATED APPLICATIONS

The present application is a continuation-in-part application of U.S. patent application Ser. No. 13/043,285 entitled INVENTORY PRICE OPTIMIZATION, the entirety of the disclosure of which is incorporated by reference herein.

### STATEMENT RE: FEDERALLY SPONSORED RESEARCH/DEVELOPMENT

Not Applicable

### BACKGROUND

1. Technical Field

The present disclosure relates generally to electronic commerce, including inventory, sales, and catalog management systems and methods. More particularly, the present disclosure relates to inventory price optimization for responding to various market conditions and for promotional purposes using a key price list.

2. Related Art

A key element to any business is the development and implementation of a successful pricing strategy. Seemingly a basic concept, the price for a given product offering must be high enough to meet the profitability and revenue goals of the seller to ensure its viability, while also being low enough for market acceptance such that the balance between production levels and demand remains optimal. Besides the profit maximization objective, pricing may be used to achieve quality leadership, cost recovery, and so forth. As a general matter, the perceived value to the customer, as well as the willingness and capacity to purchase, should be commensurate with the offered price. There may be additional variables relating to the realities of the marketplace, such as demand elasticity of the particular goods or services being sold, market position in relation to other competitors and the existence of other goods or services that are being sold.

Various pricing strategies that attempt to meet the foregoing objectives and consider these variables and more are known in the art. At the most basic level, cost-plus pricing involves calculating the cost of producing the product, and adding on a profit margin thereto, regardless of the volume purchased. Some prices may be adjusted over time as a matter of course due to external factors such as increases in production costs, raw material costs, other supplier costs, and transportation costs, inflation, deflation, etc. Further, a different price structure may be offered to dealers, wholesalers, brokers, and other professional purchasers than what is offered to consumers.

Strategies based upon competitors' prices are also known in the art. The seller may opt to lower the price of a product in relation to a competitor if there is little or no other distinction in the kind of quality of the product, also referred to as economy pricing. On the other hand, the seller may raise the price of the product if there are substantial positive differentiators. Products introduced into a new market segment may be initially priced high for a limited duration to reimburse the cost of research and development, with the expectation that certain early adopters will be less sensitive to price, a practice known as skimming. If the seller is a new entrant to the particular market, the products may be priced deliberately lower to gain customer interest and establish a presence, a practice known as penetration pricing. The base prices of certain products may be kept artificially high relative to competitors for various reasons, such as to promote the sale of a lower-priced product, or to offer promotions and sales on key products that are targeted to gain the attention of potential customers. Independent of such high-low pricing strategy, prices are oftentimes discounted to improve sales volume and profits, or to encourage sales of a particular product.

Pricing strategy is dynamic and requires constant adjustment to market conditions and employing different promotional events. Accordingly, price data for a seller's inventory is constantly being modified. For businesses with slim margins and large sales volume such as mass merchandisers, maintaining up-to-date pricing continues to be a critical undertaking. If the seller has a limited catalog of products, or inventory stock keeping units (SKUs), the tracking and updating of price data therefor may not present a substantial challenge. However, when the seller has an inventory of tens of thousands of SKUs, whether conventional, Internet/online-based, or both, the process of determining which inventory SKUs to re-price or re-pricing multiple inventory SKUs becomes time-consuming and difficult. Though inventory-wide discounts may be applied, lesser administrative burden may come at a price of lower profitability because of the untargeted nature of the sales. Accordingly, there is a need in the art for inventory price optimization methods for responding to various market conditions and for promotional purposes.

### BRIEF SUMMARY

In accordance with one embodiment of the present disclosure, there is contemplated a method for generating one or more secondary price lists from a key price list on a computer system. The method may include receiving a first selection of the key price list via a user interface of the computer system. The key price list may be stored on a catalog database and including a plurality of initial key prices associated with corresponding inventory stock keeping units (SKUs). There may also be a step of receiving a second selection of a first one of the secondary price lists via the user interface of the computer system. Additionally, the method may include a step of receiving a first price adjustment rate for the first one of the secondary price lists via the user interface after receiving the selection thereof. There may also be a step of applying the first price adjustment rate to each of the initial key prices in the key price list. A first set of secondary prices may be derived thereby. Furthermore, the method may include storing the first set of secondary prices together in association with the corresponding inventory SKUs in the first one of the secondary price lists. The first one of the secondary price lists may be stored in the catalog database. The present disclosure will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which:

FIG. 1 is a block diagram illustrating an exemplary environment in which various embodiments of the presently contemplated method for selectively adjusting a price may be implemented;

FIG. 2 is a diagram illustrating an example data structure of an inventory stock keeping unit (SKU);

FIG. 3 is an exemplary user interface for an inventory re-pricing application in accordance with one embodiment, in particular, an initial login dialog;

FIG. 4 is the user interface after a successful login, showing the various options and functions that may be invoked in the inventory re-pricing application;

FIG. 5 is a flowchart depicting a method for generating one or more secondary price lists from a key price list in accordance with one embodiment of the present disclosure;

FIG. 6 is the user interface alternatively showing a price level selection window;

FIG. 7 is the user interface showing a dialog window for copying prices from a different field and price list;

FIG. 8 is the user interface showing a filter window for selecting only certain products for re-pricing and evaluation;

FIG. 9 is the user interface showing a review screen after selecting the desired session parameters;

FIG. 10 is a flowchart depicting one contemplated method for selectively adjusting price based upon a quantity sold value;

FIG. 11 is a table showing example values in an unordered list of inventory SKUs;

FIG. 12 is another table showing the example values in a re-ordered list of inventory SKUs according to respective quantity sold values, and the categories to which they have been assigned in accordance with various embodiments of the present disclosure;

FIG. 13 is a flowchart depicting another embodiment of the contemplated method for selectively adjusting a price that is based upon a markup value;

FIG. 14 is a table showing example values in an unordered list of inventory SKUs;

FIG. 15 is another table showing the example values in a re-ordered list of inventory SKUs according to respective markup rates, and the categories to which they have been assigned in accordance with various embodiments of the present disclosure;

FIG. 16 is a flowchart depicting yet another embodiment of the method for selectively adjusting a price based upon an inventory turnover rate;

FIG. 17 is the user interface showing a re-pricing configuration setup screen;

FIG. 18 is the user interface showing a generated revised list of inventory SKUs; and

FIG. 19 is the user interface showing a forecasting screen.

Common reference numerals are used throughout the drawings and the detailed description to indicate the same elements.

### DETAILED DESCRIPTION

The present disclosure contemplates various methods for maximizing pricing, re-pricing, and implementing promotional sales on a large scale, as well as software applications that execute such methods for rapid adjustment to various market conditions such as inflation, deflation, competitor price adjustments, supplier pricing changes, and so forth. Furthermore, methods for identifying particular sets of products that are potential candidates for re-pricing are also contemplated, as are various methods for generating price lists from a key price list.

The detailed description set forth below in connection with the appended drawings is intended as a description of the several presently contemplated embodiments, and is not intended to represent the only form in which the disclosed invention may be developed or utilized. The description sets forth the functions in connection with the illustrated embodiments. It is to be understood, however, that the same or equivalent functions may be accomplished by different embodiments that are also intended to be encompassed within the scope of the present disclosure. It is further understood that the use of relational terms such as first and second, top and bottom, and the like are used solely to distinguish one from another entity without necessarily requiring or implying any actual such relationship or order between such entities.

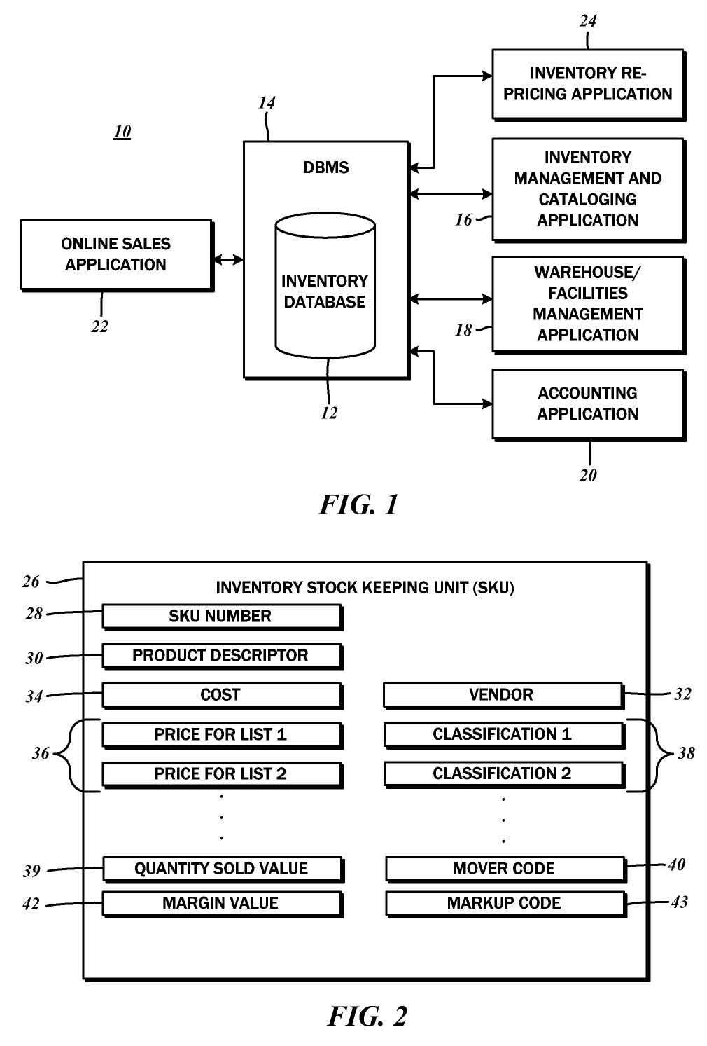

With reference to the block diagram of FIG. 1, the contemplated methods for selective re-pricing may be implemented in an enterprise resource planning (ERP) system 10 that, among other functions, manages the inventory of products that are being sold by a particular retailer. The details of the retailer's inventory are stored in an inventory database 12, and include various data fields that will be considered more fully below. A database management system (DBMS) application 14 may provide an interface to the inventory database 12 that receives queries from various external components and generates responses thereto. By way of example, the database management system application 14 may be a Structured Query Language (SQL) server.

The ERP system 10 may include numerous components that interface with the inventory database 12 to utilize the data stored thereon. Among these is inventory management/cataloging application 16, through which the retailer updates the inventory database 12 with new stocked products, remove products that are no longer carried, update some pricing, and so forth. Additionally, there may be a warehouse or facilities management application 18 that is utilized for order fulfillment and physical tracking of inventory. An accounting application 20 may access the inventory database 12 to tally the total number of sales for reporting, auditing, and other purposes. Online retailers may have a separate web server application 22 that communicates with the inventory database 12 to take and direct the fulfillment of customer orders. In accordance with the present disclosure, there is an inventory re-pricing application 24 that implements the contemplated methods.

As noted above, the inventory database 12 includes data fields in a table that store attributes of the products carried by the retailer. An individual entry in the inventory database 12 can also be viewed as a data object, with the inventory database 12 storing multiple ones of such data objects. FIG. 2 represents such a view, showing a single inventory stock keeping unit (SKU) 26. Associated therewith is an SKU number 28 that is serves as a unique identifier for the product. The inventory SKU 26 also includes a product descriptor 30, as well as a product vendor identifier 32. The cost for the product to the retailer is set forth in a cost identifier 34. The price for which the inventory SKU 26 is sold can be varied, and associated with various price lists, so there are multiple price identifiers 36. In some cases, as will become more relevant below, the price for one price list may be a predetermined percentage of another list. The product may fall into one or more categories, so there are also multiple classification identifiers 38. Although only two of each is shown, there may be additional ones.

Historical sales data is also recorded. One is a quantity sold value 39 that indicates the number of the particular inventory SKU 26 sold within a predefined time period, which in some embodiments, is set to 30 days. Longer time periods such as 90 days or 180 days are also possible. Another historical sales data that is based upon the quantity sold value 39 is a mover code 40 or sales segment category. The margin of the particular inventory SKU 26, which is defined as the gross profit margin (typically selling price minus cost), or markup over total revenue, is recorded in a margin value 42. Alternatively, as is oftentimes utilized in the art, the margin value 42 may describe a markup between the cost of the item and the price for which it is sold.

The description of the inventory re-pricing application 24 herein is in the context of a retailer dealing in parts and accessories for antique, classic or otherwise discontinued vehicles. Thus, certain disclosed features may appear to be particular to such a retailer environment. For example, one of the classification identifiers 38 may be a specific vehicle type with which the part/inventory SKU 26 is compatible, but his relationship can be defined more broadly as the vehicle type being a primary product line classifier. Those having ordinary skill in the art will recognize the interchangeability of such terminology with others specific to a different implementation context. In another example, the pricing structure may be such that sales to a dealer, distributor, jobber, etc. may be lower than that offered to a consumer. In some instances, the consumer and/or the trade professional may be offered additional discounted pricing. Analogous pricing structures are also known in different industries. The particular arrangement of the inventory SKU 26 as shown in FIG. 2 is also by way of example only, as there are multiple ways in which the inventory database 12 may be implemented. Generally, it will be appreciated that the features disclosed herein may be utilized in connection with other industries.

The ERP system 10 manages many other aspects of the retailer's operation besides those expressly illustrated herein, and those mentioned are presented by way of example only and not of limitation. Along these lines, the block diagram of FIG. 1 is intended to illustrate the logical or functional subparts of the ERP system 10, and not to limit the functionality associated therewith to any specific hardware or software component. For example, each of the aforementioned components may be a separate module running under an integrated ERP platform such as InOrder® from Morse Data of Dover, New Hampshire, or SAP® ERP from SAP AG of Waldorf, Germany. Other, more industry-specific platforms with functionality limited to inventory management, and are offered as off-the-shelf products are also contemplated. Each of these components may be running on a single server computer hardware device including, in its most basic form, a processor, random access memory, and a permanent storage device. To the extent these components are accessed from other computer systems, there may also be associated network communications devices. Those skilled in the art will be capable of configuring the hardware systems tailored to the particular needs of the retailer.

In accordance with various embodiments, the inventory re-pricing application 24 remotely accesses, over a network communications modality, the inventory database management system application 14, and is therefore a standalone software application that performs one or more steps of the presently contemplated method for selective re-pricing. Thus, the corresponding software instructions may be stored and executed on a computing device with a program storage medium readable thereby.

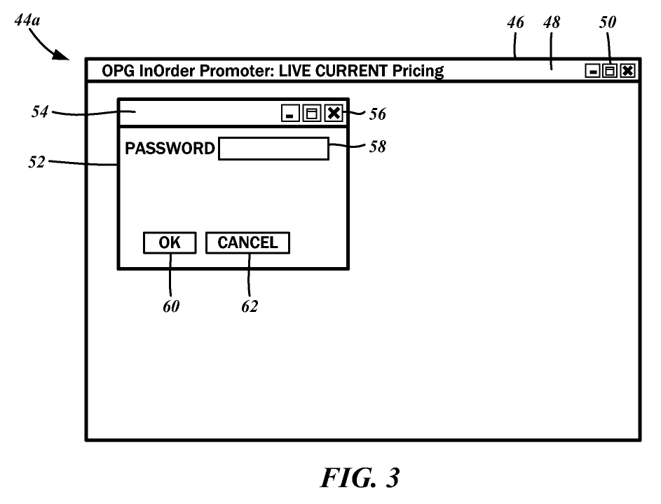

FIG. 3 shows an exemplary user interface 44a of the inventory re-pricing application 24. As is common to most window-based software applications, various functional and interactive features are contained within a main window 46 that includes a title bar 48 with basic window controls 50, which permit the user to minimize, maximize, and close the main window 46. Pricing data of the kind being modified in the inventory re-pricing application 24 is sensitive and accordingly kept secure in order to maintain a competitive edge. Thus, when first accessing the inventory re-pricing application 24, a password entry sub-window 52 is displayed. Like the main window 46, the password entry sub-window 52 includes a title bar 54 and basic window controls 56. There is a password entry box 58, an OK button 60, and a CANCEL button 62. Upon entering a valid password, the various features of the inventory re-pricing application 24 are rendered accessible, as will be described in greater detail below.

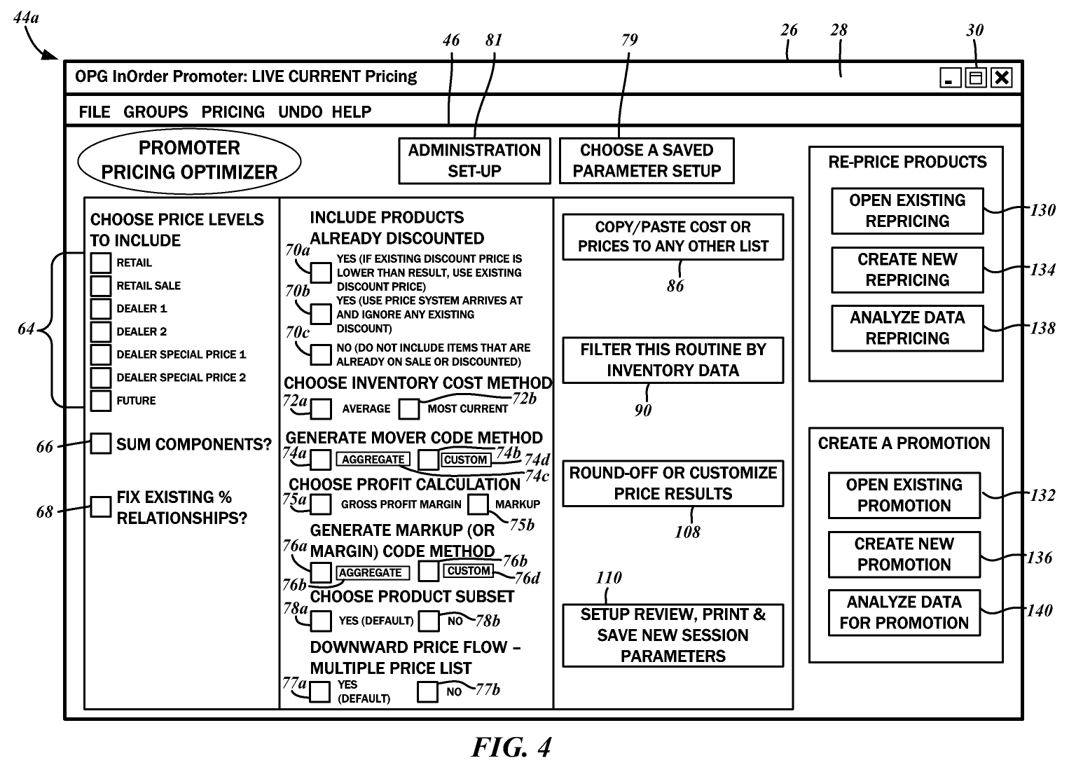

Referring now to FIG. 4, the exemplary user interface 44a is shown after the user has successfully logged in per above. As earlier indicated, the inventory SKUs 26 may be associated with multiple price lists, that is, a single inventory SKU 26 may have several different prices. From the user interface 44a, the various price lists upon which the analytics and the re-pricing features of the inventory re-pricing application 24 are applied is selected via a series of checkboxes 64. Multiple price lists may be selected, and operated on at once. Again, there is understood to be multiple retail and dealer price lists. In the particular industry of the exemplary retailer, some inventory SKUs 26 are part of a kit that may also involve a substitution of one inventory SKU 26 for another. Via a checkbox 66, a selection to sum the prices for the constituent inventory SKUs may be made. Between certain price lists, as was also mentioned above, there is understood to be certain pricing relationships. For instance, all of the prices in the retail sale list may be reduced by a predefined percentage (e.g., 10%) in comparison to the retail list. With the selection of a checkbox 68, any re-pricing operation maintains this relationship.

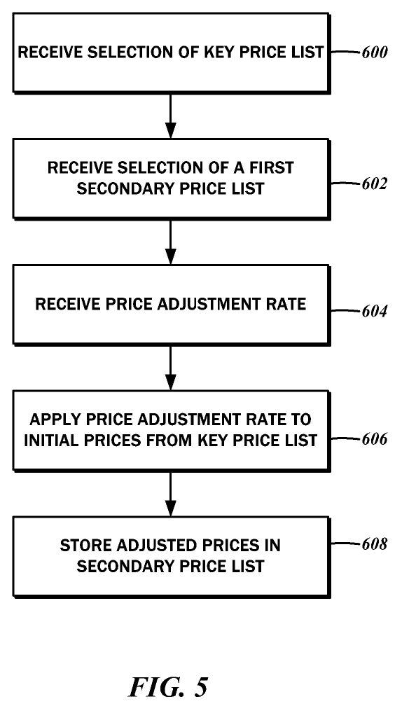

Relationships between multiple price lists can be further defined per another embodiment of the present disclosure. That is, a logical flow of price data from one list to the next, and how each price list interacts with another, may be defined in accordance with a method for generating one or more secondary price lists from a key price list. Further details pertaining to this method are shown in the flowchart of FIG. 5, and starts with a step 600 of receiving a first selection of the key price list via the user interface 44b.

As indicated above, each of the SKUs 26 stored in the inventory database 12 includes one or more price identifiers 36. Accordingly, a price list can mean a logical grouping of SKUs 26 without a separate and independent data structure that represents a listing of each SKU number 28 and price identifier 36 that makes up such logical grouping. However, considering the price list as a separate data structure of a collection of SKU numbers 29 and price identifiers 36 will better facilitate the discussion of the relationships and interactions between multiple price lists in accordance with the aforementioned method. Regardless of how a price list is defined in relation to the database 12, those having ordinary skill in the art will recognize the particular data processing steps to be taken to implement the various functions described herein. A key price list is understood to refer to the list of main prices from which all other prices are derived, i.e., percentage increases and percentage decreases in other price lists are calculated from these key prices.

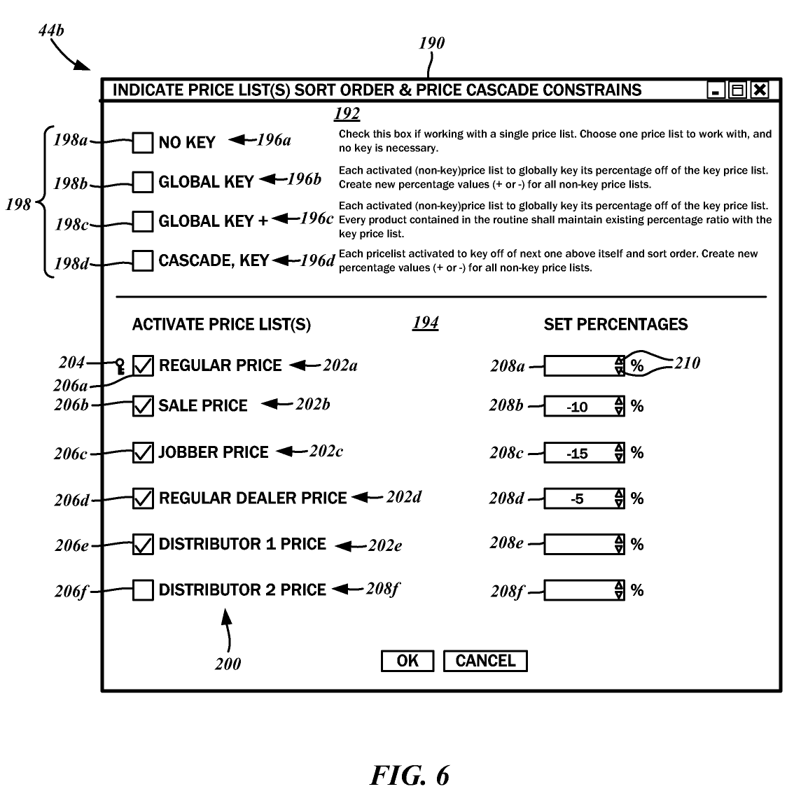

Referring now to FIG. 6, an alternative user interface 44b showing a price level setup and selection window 190 may be utilized to accept the first selection of the key price list. The same price level setup and selection window 190 can also be utilized to accept/receive a second selection of one or more secondary price lists in accordance with step 602 of the method. In further detail, the price level setup and selection window 190 is segregated into a setup section 192, which is utilized to broadly specify a type of relationship the multiple price lists are to have, and a price list selection section 194, which is utilized to specify each of the price lists that are to be part of the relating operations set via the setup section 192.

There are several relationship types that can be selected from the setup section 192, including a first option 196a for a no-key mode, a second option 196b for a global key mode, a third option 196c for an enhanced global key mode, and a fourth option 196d for a cascade mode. Each of the options 196 is selectable via corresponding radio buttons 198a-198d, though only one can be activated or selected at any given time. That is, the selection of the options 196 is mutually exclusive. Generally, the no-key mode option 196a can be selected where the re-pricing routine, the details of which will be discussed more fully below, involves a single price list. The global key option 196b is used to derive multiple secondary lists that are calculated from a single key price list. The enhanced global key option 196c allows for the maintaining of existing relationships among different price lists (i.e., as defined by the price identifiers 36) within individual SKUs 26, to the extent they have already been defined, without being overridden by any set global price adjustment rate. The cascade key option 196d allows for multiple secondary price lists to be calculated off one another, where a first secondary price list is calculated as a percentage increase or decrease of the key price, with a second secondary price list calculated as yet another percentage increase or decrease of the first secondary price list, and so forth. Various examples of the foregoing options will now be illustrated with sample price lists and sample price adjustment rates as shown in the price level setup and selection window 190.

In one embodiment, the contemplated steps 600 and 602 of receiving the selections of the key price list and secondary price lists can be facilitated by the price list selection section 194 of the price level setup and selection window 190. There is a catalog 200 of available price lists 202. There are six example price lists 202 in the catalog 200, including a regular price list 202a, a sale price list 202b, a jobber price list 202c, a regular dealer price list 202d, a first distributor price list 202e, and a second distributor price list 202f. Typically, the price lists 202 are arranged in reverse or descending order, with the list having the highest prices being arranged first or at the top, with the list having the lowest prices being arranged last or at the bottom. This arrangement is the most useful where discounts or negative price adjustment rates are applied to the key price list in subsequent secondary price lists. An alternative, ascending arrangement is also possible, and would most likely be applicable to a scenario where increasing markups or positive price adjustment rates are applied to the key price list in subsequent secondary price lists. Notwithstanding the preferred embodiments in which the price adjustment rates are ordered in one direction or another, it is also possible for there to be no order at all. Some price lists and corresponding price adjustment rates may be set negative relative to the key price list while some others are positive relative to the key price list. The foregoing price lists are presented by way of example only and not of limitation, and any other suitable name may be utilized. Furthermore, the number of price lists shown in the price list selection section 194 is also by way of example, and any additional or fewer price lists is also possible.

Next to each of the descriptors of the price lists 202a-202e are corresponding checkboxes 206a-206e. As will be recognized by those having ordinary skill in the art, through the user interface 44b, such checkboxes 206 may be selected, in which case an icon or other indicator is shown within, or deselected, in which case the checkboxes 206 are empty. In the illustrated example, the regular price list 202a corresponds to the key price list, as indicated by a key icon 204. Typically, the first price list that is selected amongst the catalog 200 is designated the key price list. When another price list besides the first listed price list in the catalog 200 is selected, then so long as it is the highest of the price lists selected, it is designated as the key price list. In other words, the price list having the highest prices is typically the key price list. Subsequent selections are designated the secondary price lists, so the additional selection of the sale price list 202b designates this as a first one of the secondary price lists. Price lists further down the catalog 200 may be selected as additional secondary price lists. It is possible to skip over certain price lists without it being selected as one of the secondary price lists. In embodiments where there is a link from one price list to another, the link skips over the deselected price list and established with the next selected price list.

The contemplated method also includes a step 604 of receiving a first price adjustment rate for the first one of the secondary price lists. Rendered in alignment with the indicator of each of the price lists 202a-202f are corresponding input boxes 208a-208f. The input boxes 208 are capable of accepting numerical text input, though direction buttons 210 can be utilized to increase or decrease the number currently displayed and set therein. It is understood that the price adjustment rates are to be percentages of the key price list, and as mentioned above, can be specified in negative as well as positive terms.

Upon selection of the key price list (the regular price list 202a) and the first secondary price list (the sale price list 202b), the method continues with a step 606 of applying the price adjustment rate for the first secondary price list that was specified in the input box 208b. Regardless of the mode or relationship type selected from the setup section 192, the first secondary price list is applied the specified price adjustment rate. Upon calculation, the modified values may be stored in the first secondary price list, with such changes being committed to the individual SKUs 26 and associated price identifiers 36.

Additional steps are contemplated for when a second secondary price list (the jobber price list 202c, for example) is selected, and a price adjustment rate is specified in the corresponding input box 208c. When the global key option 196b is selected, the price adjustment rate is applied against the key price list. Thereafter, any secondary price list is calculated from the adjusted rate. Thus, in the example, a 10% discount is applied to the key price list to derive the first secondary price list (sale price list 202b), with a 15% discount specified in the input box 208c also being applied to the key price list (the regular price list 202a) for the second secondary price list (the jobber price list 202c). In other words, both of the selected secondary price lists (the sale price list 202b and the jobber price list 202c) are “keyed” off of the key price list (regular price list 202a).

When the enhanced global key option 196c is selected, if there are existing relationships between the second secondary price list (the jobber price list 202c) and the key price list (the regular price list 202a) whether lower or higher than the specified 15% discount, then such preexisting discounts or markups are maintained. This is also understood to apply to the first secondary price list (the sale price list 202b). Since the global price adjustment rates would no longer be applicable, any values specified via the input boxes 208 are understood to be ignored.

The cascade key option 196d, when selected, essentially “keys” the pricing of the second secondary price list (the jobber price list 202d) off the first secondary price list (202b), so forth. This means that specified price adjustment rate is applied to the price list from which it is keyed. Accordingly, in the example shown, a 10% discount is applied to the key price list (the regular price 202a) for the first secondary price list (the sale price 202b), and a 15% discount is applied in turn thereto for the second secondary price list (the jobber price 202c). A subsequently selected secondary price list, such as a potential third secondary price list (the regular dealer price 202d), the specified discount of 5% in the input box 208d is applied to the second secondary price list (the jobber price 202c). The cascade key option 196d thus allows for the creation of a playful of pricing where each price adjustment rate follows the previous active price list.

There may be some cases in which the selected price lists already include a discount. Referring back to the user interface of FIG. 3, by selecting one of checkboxes 70a-c, such pre-existing discounts may be handled differently. Selecting the first checkbox 70a compares the existing discount to the newly specified discount, and using the lower of the two. Selecting the second checkbox 70b applies the newly specified discount without a comparison to the pre-existing discount. Selecting the third checkbox 70c excludes any inventory SKUs 26 that already have discounts applied thereto from further processing.

Having considered the pricing flow options contemplated by the present disclosure, further details regarding the other possible options and functions that may be invoked through the user interface 44a will be considered. Referring again to FIG. 4, different ways of calculating the aforementioned inventory cost can be set via a pair of checkboxes 72a, 72b, only one of which can be set at a time. Since the cost to the retailer can fluctuate over time, different ways of handling such fluctuation in inventory re-pricing application 24 are envisioned. Selecting the “average” checkbox 72a envisions the re-pricing strategy to be based on mean cost over a predefined time period, whereas the “most current” checkbox 72b utilizes only the recent cost. There may be one of two methods by which the mover code 40 is generated. The application of the mover code 40 will be considered in greater detail below, but generally, with the “aggregate” setting, the entirety of the inventory database 12 is utilized, while with the “custom” setting, user-selected subsets of the inventory SKUs 26 are utilized. The “aggregate” setting is selected via a checkbox 74a, whereas the “custom” setting is selected via a checkbox 74b, the two checkboxes being mutually exclusive. Further parameters for these settings may be entered by selecting active buttons 74c, 74d.

As described above, different inventory SKUs 26 may have different margins or markups. These markup/margin levels can be classified into different categories, with such categorization assisting in the review of re-pricing decisions. With reference to FIG. 2, markup codes 43 corresponding to these categories may be associated with the inventory SKU 26. Where it is desired to categorize the inventory SKUs 26 based upon the gross profit margin, a checkbox 75a is selected, while if it is desired to categorize the inventory SKUs 26 based upon the markup, then a checkbox 75b is selected. The generating of the markup code 43 is enabled by default through a checkbox 76a, while custom method may be selected through a checkbox 76b. Again, further parameters for these settings may be entered by selecting active buttons 76c, 76d.

Typically, each inventory SKU 26 uniquely identifies a specific product, in a specific configuration. Thus, every minor variation may each assigned different inventory SKU 26. For example, a product may be sold in two sizes (e.g., small and large) as well as two colors (red and blue). In this case, there are four separate inventory SKUs 26, one for a small red, another for a small blue, still another for a large red, and yet another for a large blue. Via a checkbox 78a, it is possible to consolidate, for purposes of re-pricing/promotions analysis, all of these variations as one unit. If it is necessary to separately consider these variations, a checkbox 78b may be selected. The checkbox 78a and the checkbox 78b are understood to be selectable in a mutually exclusive relationship.

While adjusting prices across multiple price lists, there is a possibility that one price list may have one or more inventory SKUs 26 that are higher or lower than another list, even when there should not be such a variation. For example, a retail price should be higher than a dealer price. To ensure that this general pricing relationship is retained, an option to enforce a price flow may be selected via a checkbox 77a. Otherwise, a checkbox 77b, which is understood to be mutually exclusive with the checkbox 77a, can be selected.

The above parameters may be defined and saved for subsequent retrieval and use. In order to select such pre-defined set of parameters, a button 79 may be selected. Along these lines, various other administrative-level options may be set via first selecting a button 81.

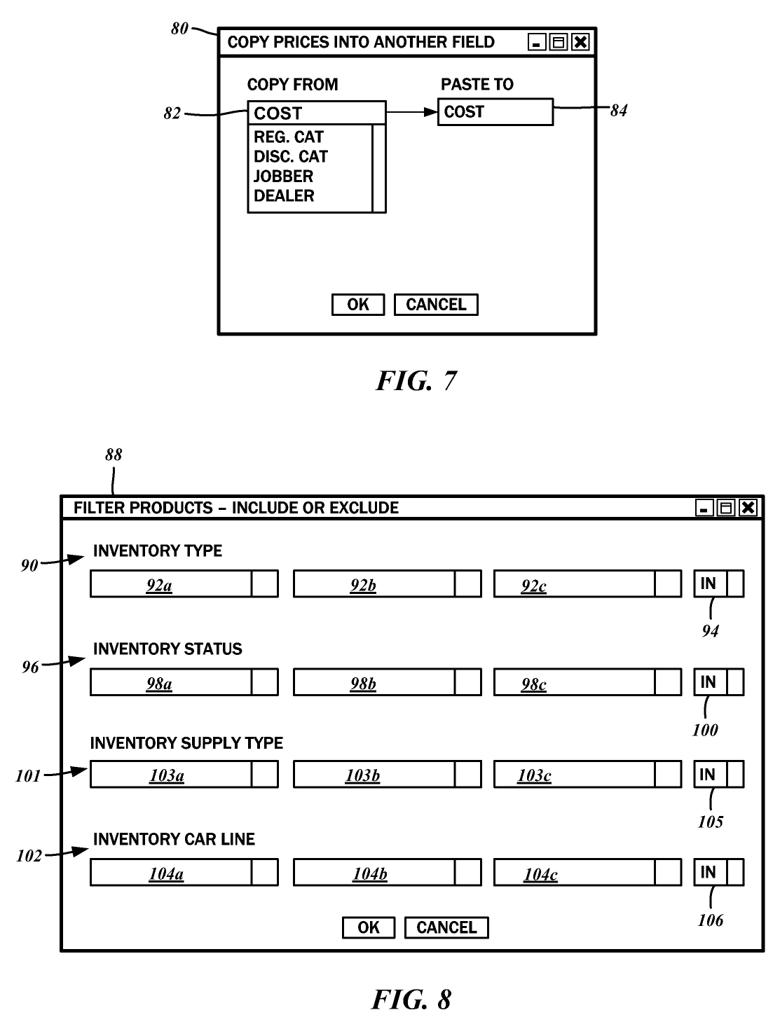

Upon selecting the options discussed above, several other processing parameters may be set. Instead of utilizing the pre-existing price lists that are selectable via the checkboxes 64, it is also possible to copy from one price list to another for further manipulation. FIG. 7 shows an exemplary user interface with a dialog window 80, including a source selector 82, and a destination selector 84. Thus, it is possible to work from more precise figures for re-pricing purposes. From the main window 46, a button 86 may be pressed to invoke this feature.

In some limited circumstances, a re-pricing or promotional event could be applied to the entire inventory of the retailer. In most cases, however, only selected products or product segments are considered. Referring to FIG. 8, there is shown one exemplary filtering window 88 user interface, which may be invoked by selecting a button 90. Under a first heading 90, various types of inventory can be selected for inclusion or exclusion. As noted above, the inventory SKU 26 has one or more classification identifiers 38, and among these is the inventory type, such as “gift Certificates,” “Aftermarket,” “High Performance,” Video and Software” and so forth. These classification identifiers are selectable via pull-down menus 92a-92c. Another set of pull-down menus 96 has two options for either including or excluding the specified inventory type. The pull-down menus are similar under a second heading 98, which corresponds to inventory status, including available, component, discontinued, not yet available, not available, unlimited supply, and drop ship. Again, there is a pull-down menu 100 for including or excluding the selected parameters. Under a third heading 101 there is a set of pull-down menus 103a-103c for selecting an inventory supply type, which is another classification identifier. There is also a pull-down menu 105 to select whether to include or exclude the specified parameters with the filter functionality. Under a fourth heading 102 there are another set of pull-down menus 104 for selecting an inventory car line, which corresponds to another classification identifier 38 as previously described.

The filtering window of FIG. 8 is exemplary only, and may differ depending upon the organization of the inventory database 12 and the arrangement of the inventory SKU 26. In this regard, other fields that may be associated with the inventory SKU 12 may serve as a filtering parameter. These include, by way of example only, suppliers or vendors to include or exclude, sales regions to include or exclude, and website categories to include or exclude, among many others. Further, there are several ways in which such filtering functions can be implemented from the user interface perspective. Any alternatives will be discernible to one of ordinary skill in the art.

According to some theories, pricing, and in particular, the ending numbers of a price, may be modified for maximum psychological impact in relation to customer perception of low price or value. For example, instead of selling an item for $4.00, it could be sold for $3.95 while anticipating a higher demand. Although there is only a five cent difference, the initial three dollars has impact. The present disclosure thus contemplates the modification of the price suffix (cents) to be maintained at a specific value regardless of any other re-pricing process. This option is selectable via a button 108.

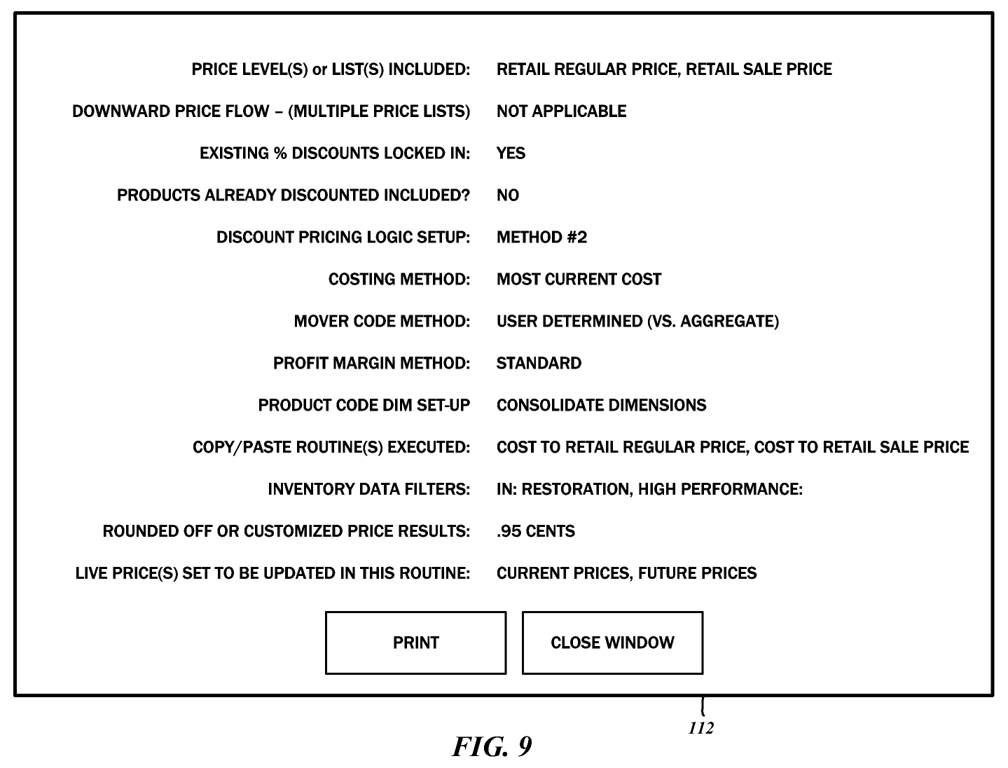

After setting all of the parameters as desired, a button 110 invokes the function to review, print, and save the session parameters as discussed above. FIG. 9 is one exemplary review screen 107 that shows the parameters in a convenient, single page format.

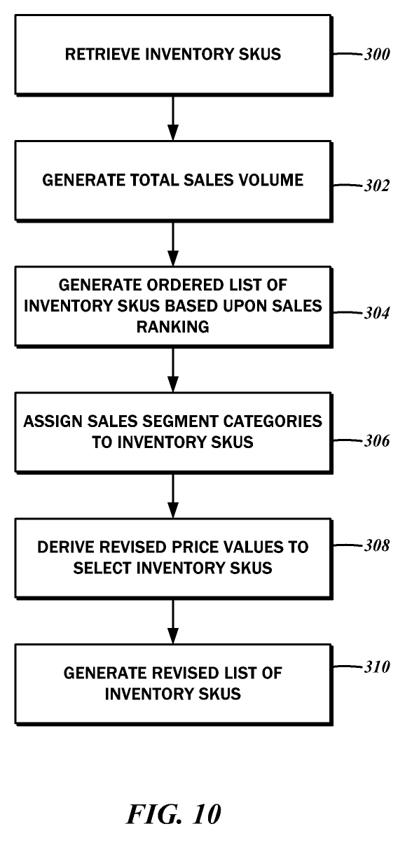

Referring now to the flowchart of FIG. 10, a method for selectively adjusting the price associated with one or more inventory SKUs 26 will be considered. As briefly mentioned above, re-pricing and other related analyses are typically not conducted on the entirety of the inventory database 12, but select ones. Beginning with a step 300, the method begins with retrieving at least a subset of the inventory SKUs 26 in the catalog or inventory database 12. However, this does not mean that an operation on the entirety of the inventory database 12 is not possible.

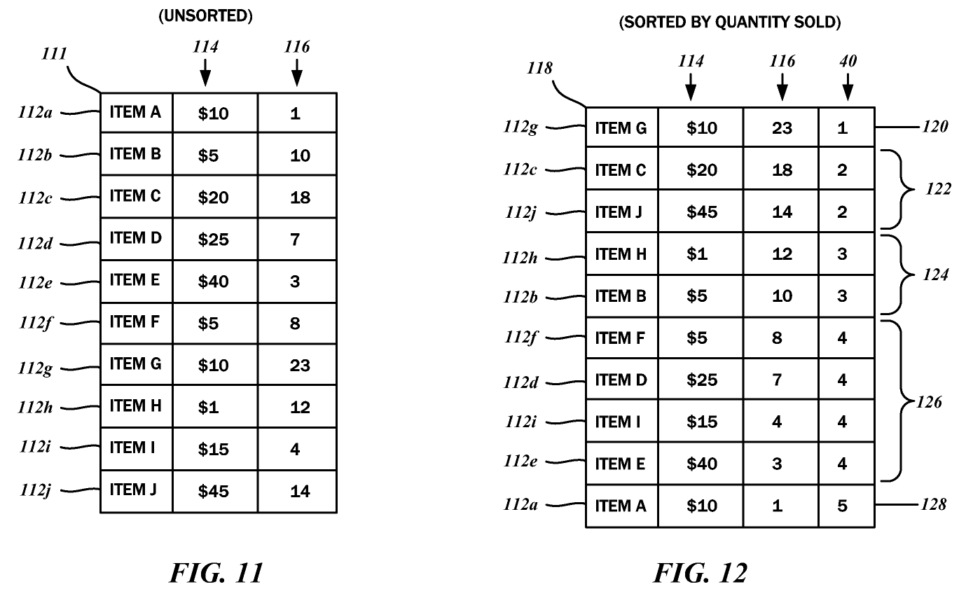

A simplified example of the retrieved inventory SKUs 26 is shown in the table 111 of FIG. 11, including ten items, that is, item A 112a, item B 112b, item C 112c, item D 112d, item E 112e, item F 112f, item G 112g, item H 112h, item I 112i, and item J 112j. Each has a price 114 associated therewith, as well a quantity sold value 116. The method will be described with reference to this example. It will be recognized that the table 111 and table 118 are generally not visible to the user, and are presented for purposes of illustrating certain aspects of the disclosed method. As indicated above, the quantity sold value 116 is the number of the particular product sold within a predefined time period, which can be 30 days, 90 days, etc. In the example table 111, the item G 112g has moved 23 units in the relevant time period.

The method continues with a step 302 of generating the total sales volume of all products 112a-j in the table 111, which in the example is 100 total sales. Next, in accordance with a step 304, the list in the table 111 is re-sorted according to each item's quantity sold value 116 from highest to lowest as shown in table 118.

Thereafter, the method continues with a step 306 of assigning sales segment categories to the inventory SKUs 26. One aspect of this step involves dividing the total sales volume into several distinct groups equal in number, also known as frequency distributions. In one contemplated embodiment, there are to be five (5) groups, though any other number of groups may be utilized. Thus, to simplify the equation, with the total 100 items sold, there may be five groups of 20 items sold each. Thus, each item becomes categorized by sales movement based upon their particular volume of sales against the aggregate total of sales. The size of this group is also referred to as a segment threshold.

Another aspect involves the keeping of running tallies of the quantity sold value 116 down the reordered table 118 or list, and assigning the sales segment category to that particular item 118 based upon the running tallies meeting the segment threshold. The sales segment category may also be referred to as the mover code 40, which is a numerical value between one and five corresponding to the five sales segment categories. As indicated above, the mover code 40 becomes associated with the inventory SKUs 26. For example, with the item G 118g having 23 units sold, it alone exceeds the segment threshold of 20, and hence assigned to a first sales segment category 120, that is, assigned a mover code of 1. Next, with item C 118c, the tally re-starts, and does not exceed the segment threshold. With the next item J 118J by adding 14 and 18, exceeds the segment threshold and thus assigned a second sales segment category 122, or a mover code of 2. Again, the tally re-starts with item H 118h, and continues to item B 118b until the segment threshold is exceeded. These two items are assigned a third sales segment category 124, that is, a mover code of 3. The tally re-starts with item F 118f, and continues until item E 118e, when it finally exceeds the segment threshold at 22. These items are assigned a fourth sales segment category 126 or a mover code of 4. This process continues until no further items remain. In the example item A 118a is the sole one in the fifth sales segment 128 and assigned a mover code of 5.

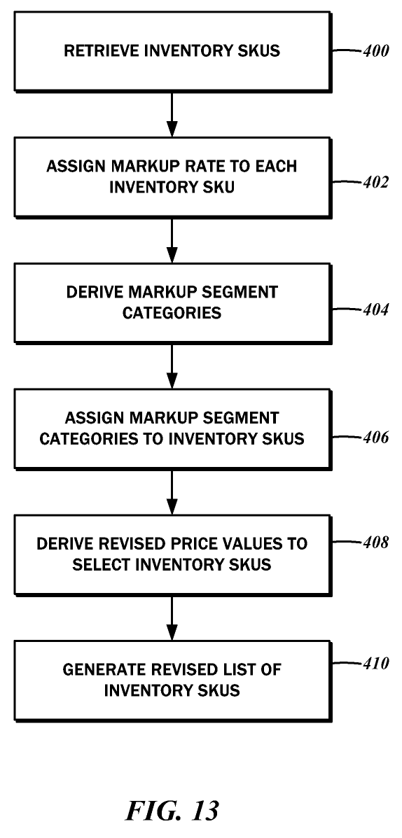

With reference to the flowchart of FIG. 13, another method for selectively adjusting prices based upon different price markups for inventory SKUs 26 is contemplated. Similar to the method based upon the sales quantity discussed above with reference to FIG. 10, the method begins with a step 400 of retrieving at least a subset of the inventory SKUs 26 in the inventory database 12.

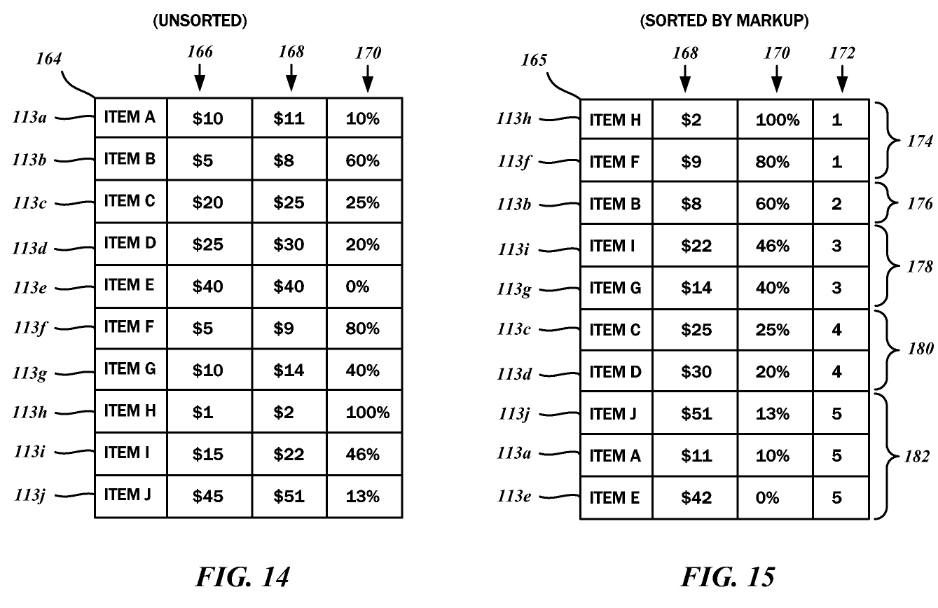

Another simplified example of the retrieved inventory SKUs 26 is shown in a table 164 of FIG. 14 that includes item A 113a-item J 113j, and the method will be discussed in relation thereto. Each of the items 113 has an associated cost value 166 that generally corresponds to the cost identifier 34 of a given inventory SKU 26, as well as a price value 168 that indicates the price for which the corresponding item 113 is sold. The price value 168 is understood to correspond to the price identifier 36 of the inventory SKU 26.

The method then proceeds to a step 402 of assigning a markup rate 170 to each of the items 113 or inventory SKUs 26. The markup rate 170 is expressed as a percentage of the price value 168 over the cost value 166, subtracted by 1, though any other suitable expression of markup may also be utilized. As shown in FIG. 14, the listing of the inventory SKUs 26 in the table 164 is arranged according to an item identifier and otherwise unsorted.

In accordance with a step 404, a plurality of market segment categories 172 are derived. These are based off the lowest one of the markup rates 170 for item E 113e, which is 0%, and the highest one of the markup rates 170 for item H 113h, which is 100%. The difference between the highest and the lowest of the markup rates 170 is divided by a segment division factor, thereby defining one or more categories spanning the same percentage differences. In accordance with one contemplated embodiment, the segment division factor may be five, thus creating five categories of 20%, from highest to lowest: 100% to 80%, 79% to 60%, 59% to 40%, 39% to 20%, and 19% to 0%. It will be recognized, however, that the segment division factor may be any value.

Per step 406, the markup segment categories 172 are assigned to each of the retrieved inventory SKUs 26 based upon its markup rate. Items H 113h and F 113f are assigned a first markup segment category 174, since at 100% and 80%, fall within the first or highest of the five categories of 20% noted above. Item b 113b is assigned a second markup segment category 176, with its 60% markup being the only one in the second highest of the five categories of 20%. Next, items I 113i and G 113g are assigned a third markup segment category 178 for having a 46% and a 40% markup, respectively. Items C 113c and D 113d are assigned a fourth markup segment category 180 for having a 25% and a 20% markup, respectively. Items J 113j, A 113a, and E 113e are assigned a fifth markup segment category 182 as having the lowest quintile of markups at 13%, 10% and 0%, respectively. The table 165 is sorted according to the markup rate 170, with the pricing being adjustable along these different markup segment categories as will be discussed below.

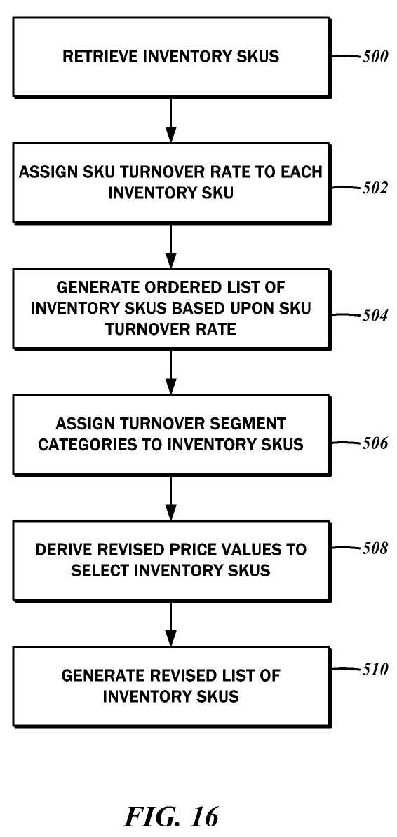

Another embodiment of the present disclosure contemplates a method for selectively adjusting prices based upon how much of the particular item is in stock, and how many days worth of “stock on hand” is available. As will be recognized, typical retailers prefer to have the entire stock of any given item cycle in 30 days Thus, pricing may be reduced on overstocked items and increased on understocked items to achieve this objective. As shown in the flowchart of FIG. 16, the method likewise includes a step 500 of retrieving the inventory SKUs 26 as discussed above in relation to steps 300 and 400.

The method then continues with a step 502 of assigning an SKU turnover rate identifier to each inventory SKU 26. It is understood that the SKU turnover rate is based upon the quantity available of the particular inventory SKU 26, and the number of units sold in the past, for a predetermined timespan that may be 30 days, 60 days, 90 days, or any other number of days. The SKU turnover rate thus estimates how long any given inventory SKU 26 remains on the shelf, and is specified as a numerical value of days.

A step 504 involves generating an ordered list of the inventory SKUs 26 that is based upon the SKU turnover rates derived above. In a step 506, the method assigns a turnover segment category to each of the inventory SKUs 26 in the same manner discussed above in relation to step 306. In particular, the assigning of the turnover segment categories contemplated to be based upon sequential running tallies of the SKU turnover rate associated with the inventory SKUs in the ordered list. The tallies for the turnover segment categories may meet a segment threshold that is defined at least in part by a highest SKU turnover rate and a lowest SKU turnover rate in the ordered list.

Referring back to FIG. 10, the method shown therein also includes a step 308 of deriving revised price values to select inventory SKUs. The price values that are revised may be from a particular sales segment category, a combination of several sales segment categories, or any other criteria that has been discussed previously, including one or a combination of markup segment categories, and one or a combination of inventory turnover segment categories. The contemplated methods have equivalent steps 408 and 508. Along these lines, while several different variations of the categorization of the inventory SKUs 26 based upon variable attributes thereof have been disclosed, these are by way of example only and not of limitation. Where other variables are tracked in the inventory database 12, then those variables can also be the basis for categorization operations.

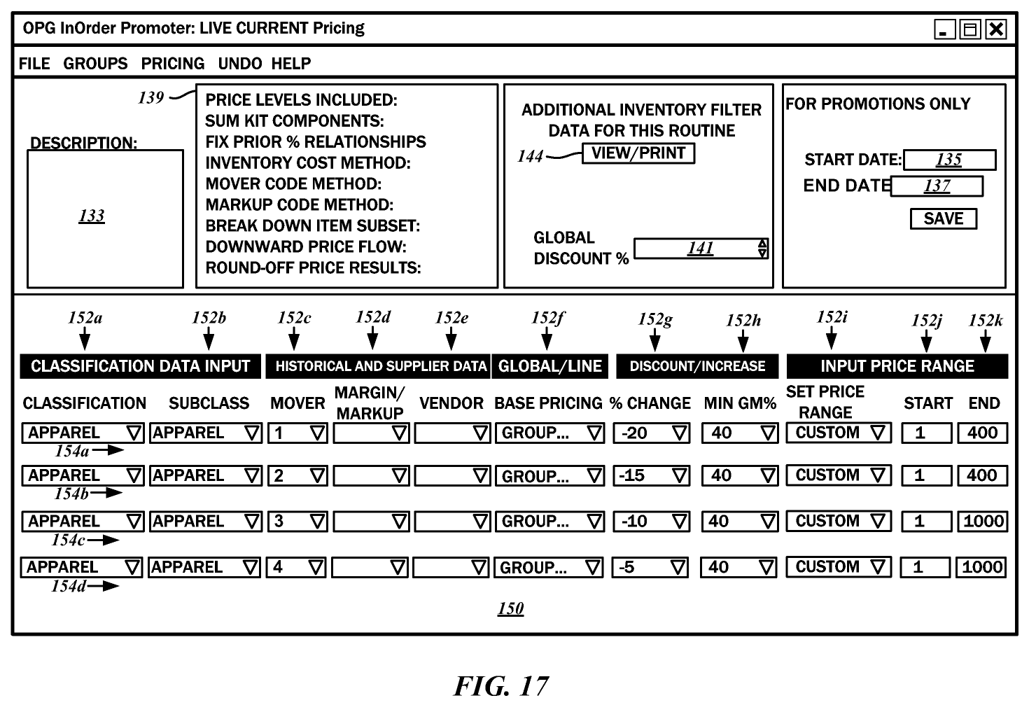

Certain limitations can be placed on the way such re-pricing operations function. The user interface shown in FIG. 17 is a re-pricing configuration setup screen, which can be invoked from any one of several user interface elements of the main window 46 shown in FIG. 4.

Generally, inventory re-pricing application 24 may be used for permanent price setting, or for temporary promotional events. The functionality associated with these two activities are substantially equivalent, but for purposes of convenience to the user, have been segregated. The re-pricing configuration may be saved for subsequent retrieval that is accessed via a button 130 for permanent re-pricing, and a button 132 for promotional pricing. A new re-pricing configuration may be started via a button 134 and a button 136 for permanent re-pricing and promotional pricing, respectively. Instead of performing re-pricing operations, a sales analysis may be conducted, the functionality of which is accessed by selecting a button 138 and a button 140 for permanent re-pricing and promotional pricing, respectively.

The re-pricing configuration setup screen is segregated into several sections. In a notes section 131, a basic description field 133 of the re-pricing operation is included. In a setting confirmation section 139, the various parameters that were set in the main window 46 and verified in the review screen 107 are shown. Via a view/print button 144, the filter settings may be changed. A global discount may be applied via a selection element 141. For promotions, a start date field 135 and an end date field 137 may be specified. These dates entered in these fields may be utilized for reference purposes, or also for controlling the effective dates of a promotional or sales event.

The re-pricing operation can be variously adjusted through a series of criteria and settings. In the pull-down menus of a first column 152a, the classification to which the operation applies is specified, which in the example shown, is apparel. In the pull-down menus of a second column 152b, the subclass to which the operation applies is specified. Again, in the example shown, this subclass is also apparel. Next, in the pull-down menus of a third column 152c the desired mover code or sales segment category applicable is specified. In the pull-down-menus of a fourth column 152d the markup or margin code applicable is specified. The operation can be limited to vendors, via the pull-down menus of a fifth column 152e. The pull-down menus of a sixth column 152f defines whether or not certain re-pricing parameters will be based on the values specified in the other columns of the respective row 154, or based upon a global change from entry field 141. In the pull-down menus in an seventh column 152g, the percentage to discount or increase from the initial price values is specified. In the pull-down menus in an eighth column 152h, the minimum acceptable margin is specified. In the pull-down menus in a ninth column 152i, the price range to use is specified. With the text entry boxes in a tenth column 152j and a eleventh column 152k, the low and high price limits to which the re-pricing applies can be specified. Although not shown, because a query to a conventional SQL database is being generated by each row 154 in the criteria/settings section 150, user-specified SQL queries can also be inputted.

In the example parameters set in FIG. 13, each inventory SKU 26 in the first four sales segment categories or with mover codes 1-4 in the apparel classification and sub-classification is being re-priced. For a first row 154a, which is for a mover code 1, a 20% reduction is specified but with a minimum markup or gross margin (user choice) override margin of 40%, starting with $1 items, all the way up to $400 items. A second row 154b specifies that for a mover code 2, a 15% reduction is specified but also with a minimum markup or gross margin override of 40% and starting with $1 items to $400 items. A third row 154c specifies that for a mover code 3, a reduction of 10% is specified with a minimum markup or gross margin override of 40%, and starting with $1 items to $1000 items. A fourth row 153d specifies that for a mover code 4, a reduction of 5% is specified, again with a 40% markup or gross margin override and starting with $1 items to $1000 items. In this example, prices are being lowered in the hopes that more units should sell at a lower price point.

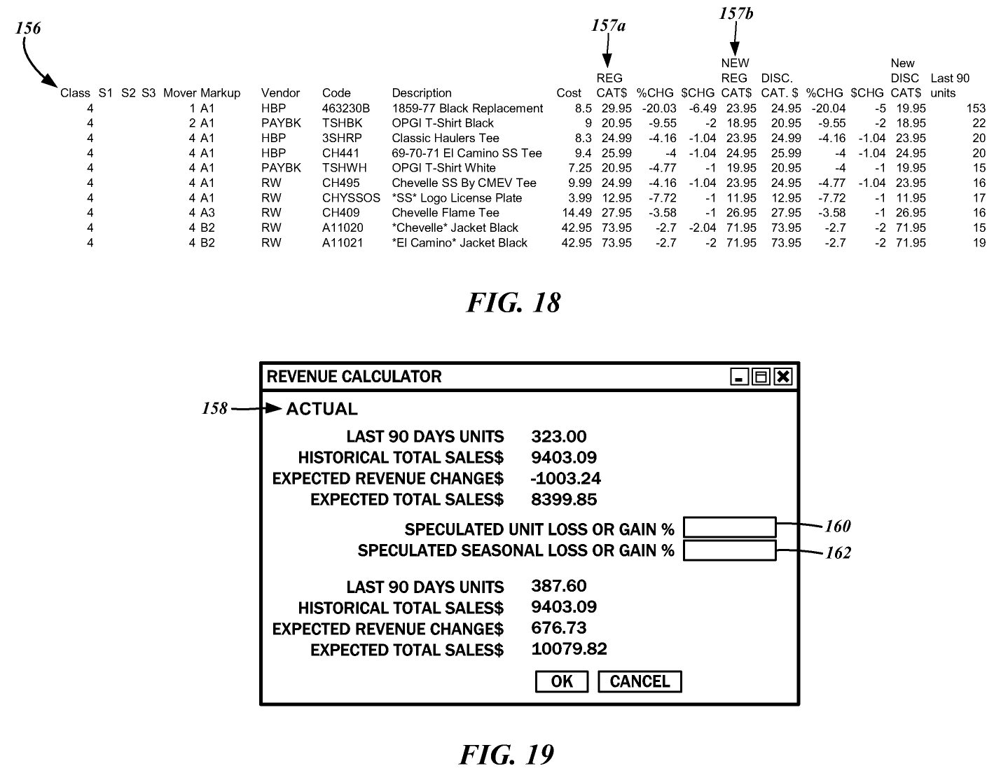

Referring back to the flowchart of FIG. 10, the disclosed method also includes a step 310 of generating a revised list of inventory SKUs with the retrieved inventory SKUs, with the revised price values substituted for the initial price values. As shown in the flowcharts of FIG. 13 and FIG. 16, the other disclosed methods have equivalent steps 410 and 510. FIG. 18 illustrates an exemplary revised list 156 with the initial prices shown in a column 157a, and the revised prices shown in a column 157b. A discount price list can also be modified as shown in the table, while maintaining relationships between the regular price list and the discount price list as discussed above. The revised list may then be committed to the inventory database 12, thus updating the prices for actual use.

In accordance with another aspect of the present disclosure, a revenue calculator based upon the revised price list is also contemplated. As shown in FIG. 19, under an actual revenue heading 158, several revenue figures and sales volume values are displayed. A speculated unit sales increase percentage value can be entered into a text input box 160, and the forecast of revenue based upon that percentage increase sales can be generated. However, there are many seasonal factors to consider when forecasting demand. At the beginning of a season, future sales volume can be expected to increase, but at the end of the season, future sales volume can be expected to decrease. The speculated sales volume increase by decreasing prices, may be bolstered or hindered by such seasonal effects. Accordingly, there is another text input box 162 for entering the forecast or commonly known seasonality changes, thereby obtaining more precise results.

The particulars shown herein are by way of example and for purposes of illustrative discussion of the embodiments of the present disclosure only and are presented in the cause of providing what is believed to be the most useful and readily understood description of the principles and conceptual aspects. In this regard, no attempt is made to show details of the present invention with more particularity than is necessary for its fundamental understanding, the description taken with the drawings making apparent to those skilled in the art how the several forms of the present invention may be embodied in practice.

What is claimed is:

1. A method for generating one or more secondary price lists from a key price list on a computer system, the method comprising:
receiving a first selection of the key price list via a user interface of the computer system, the key price list being stored on a catalog database and including a plurality of initial key prices associated with corresponding inventory stock keeping units (SKUs);
receiving a second selection of a first one of the secondary price lists via the user interface of the computer system;
receiving a first price adjustment rate for the first one of the secondary price lists via the user interface after receiving the selection thereof;
applying the first price adjustment rate to each of the initial key prices in the key price list, a first set of secondary prices being derived thereby; and
storing the first set of secondary prices together in association with the corresponding inventory SKUs in the first one of the secondary price lists, the first one of the secondary price lists being stored in the catalog database.

2. The method of claim 1, further comprising:
receiving a third selection of a second one of the secondary price lists via the user interface of the computer system; and
receiving a second price adjustment rate for the second one of the secondary price lists via the user interface after receiving the selection thereof.

3. The method of claim 2, further comprising:
applying the second price adjustment rate to each of the initial key prices in the key price list, a second set of secondary prices being derived thereby; and
storing the second set of secondary prices together in association with the corresponding inventory SKUs in the second one of the secondary price lists, the second one of the secondary price lists being stored in the catalog database.

4. The method of claim 2, further comprising:
applying the second price adjustment rate to each of the first set of secondary prices in the first secondary price list, a second set of secondary prices being derived thereby; and
storing the second set of secondary prices together in association with the corresponding inventory SKUs in the second one of the secondary price lists, the second one of the secondary price lists being stored in the catalog database.

5. The method of claim 1, wherein the first price adjustment rate is negative.

6. The method of claim 1, wherein the first price adjustment rate is positive.

7. The method of claim 1, wherein the first price adjustment rate is defined as a percentage of the initial key prices.

8. The method of claim 1, wherein the user interface includes descriptive indicators and selectable interface elements corresponding to the key price list and the secondary price lists.

9. The method of claim 8, wherein a key indicator is generated in response to the selection of the user interface element corresponding to the key price list.

10. An article of manufacture comprising a program storage medium readable by a data processing apparatus, the medium tangibly embodying one or more programs of instructions executable by the data processing apparatus to perform a method for generating one or more secondary price lists from a key price list on a computer system, the method comprising:
receiving a first selection of the key price list via a user interface of the computer system, the key price list being stored on a catalog database and including a plurality of initial key prices associated with corresponding inventory stock keeping units (SKUs);
receiving a second selection of a first one of the secondary price lists via the user interface of the computer system;
receiving a first price adjustment rate for the first one of the secondary price lists via the user interface after receiving the selection thereof;
applying the first price adjustment rate to each of the initial key prices in the key price list, a first set of secondary prices being derived thereby; and
storing the first set of secondary prices together in association with the corresponding inventory SKUs in the first one of the secondary price lists, the first one of the secondary price lists being stored in the catalog database.
